(19) United States
(12) Patent Application Publication
(10) Pub. No.: US 2019/0245795 A1
(43) Pub. Date: Aug. 8, 2019

(54) PROTOCOL TERMINATION DEVICE, RELAY METHOD, AND RECORDING MEDIUM

(71) Applicant: NEC CORPORATION, Tokyo (JP)

(72) Inventor: Yasuaki SUMIYOSHI, Tokyo (JP)

(73) Assignee: NEC CORPORATION, Tokyo (JP)

(21) Appl. No.: 16/335,744

(22) PCT Filed: Sep. 22, 2017
(86) PCT No.: PCT/JP2017/034347

§ 371 Date: Mar. 22, 2019

(30) Foreign Application Priority Data
Sep. 23, 2016 (JP) 2016-185261

(51) Int. Cl. H04L 12/825; H04L 12/26

(52) U.S. Cl. CPC H04L 47/25; H04L 43/0894

(57) ABSTRACT

A protocol termination device includes: a transfer unit configured to transfer distribution data transmitted from a distribution device to a request device that has requested the distribution data, and a suppression control unit configured to perform suppression control for monitoring a transmission amount per unit time of the distribution data being transmitted from a transmission buffer of the protocol termination device to the request device in the transfer processing and requesting transmission of the distribution data having a data amount that is equivalent to the transmission amount per unit time, from the distribution device.

### TECHNICAL FIELD

The present invention relates to a protocol termination device, a relay method, and a program.

### BACKGROUND ART

In recent years, a user who uses a mobile terminal such as a smartphone can download an application program specialized for a particular service to the mobile terminal and can receive the service provided from a distribution device connected on the Internet. In this service, the distribution device controls transmission of distribution data and the like while control signals are transmitted and received between the distribution device and the mobile terminal that uses the specialized application program. The distribution data transmitted from the distribution device are received by the mobile terminal.

A provider that provides such a service implements a scheme to reduce a load on a distribution device by applying an own rule in control of data transmission/reception between the distribution device and a specialized application program on a smartphone. For example, a request device, such as a mobile terminal, that requests distribution data receives the distribution data transmitted by the distribution device. At this point of time, the request device that has received the distribution data transmits a response or the like that indicates arrival of a packet of the distribution data, to the distribution device. When a period of time passes before reception of a response from the request device, the distribution device usually retransmits the distribution data. However, frequent occurrence of such retransmission places a load on the distribution device. The provider providing the service therefore attempts to reduce a processing load on the distribution device by setting a short period of time before it is determined that no response is transmitted from a request device and setting the distribution device in such a way as to immediately disconnect a session for which no response is received in the set period of time. Note that a related technique is disclosed in PTL 1.

### CITATION LIST

### Patent Literature

[PTL 1] Japanese Unexamined Patent Application Publication No. 2008-104018

### SUMMARY OF INVENTION

### Technical Problem

In the technique as described above, when packets of distribution data are accumulated in a relay device such as a protocol termination device provided between a distribution device and a request device, the distribution device disconnects a session after a lapse of a shorter period of time (early). Accordingly, a user cannot satisfactorily receive a service. Further, the technique in PTL 1 cited above controls a data transmission amount of data to be newly transmitted from a server device which corresponds to the distribution device described above to a client terminal which corresponds to the request device described above in a communication system in which the server device and the client device are connected.

There is a demand for a technique that can avoid a service interruption due to an early session disconnection by a distribution device as described above in a case where a communication path between the distribution device and a request device is constituted of communication networks that differ in data transmission amount per unit time and a relay device that interconnects the communication networks exists.

Therefore, an object of the present invention is to provide a protocol termination device, a relay method, and a program that solve the problem described above.

### Solution to Problem

According to the first exemplary aspect of the invention, a protocol termination device comprises: a transfer unit configured to transfer distribution data transmitted from a distribution device to a request device that has requested the distribution data, and a suppression control unit configured to perform suppression control for monitoring a transmission amount per unit time of the distribution data being transmitted from a transmission buffer of the protocol termination device to the request device in the transfer processing and requesting transmission of the distribution data having a data amount that is equivalent to the transmission amount per unit time, from the distribution device.

And, according to the second exemplary aspect of the invention, a relay method comprises: transferring distribution data transmitted from a distribution device to a request device that has requested the distribution data, and performing suppression control for monitoring a transmission amount per unit time of the distribution data being transmitted from a transmission buffer of an own device to the request device in the transfer processing, and requesting transmission of the distribution data having a data amount that is equivalent to the transmission amount per unit time, from the distribution device.

And, according to the third exemplary aspect of the invention, a program causes a computer to execute: the processing of: transferring distribution data transmitted from a distribution device to a request device that has requested the distribution data, and performing suppression control for monitoring a transmission amount per unit time of the distribution data being transmitted from a transmission buffer of an own device to the request device in the transfer processing, and requesting transmission of the distribution data having a data amount that is equivalent to the transmission amount per unit time, from the distribution device.

### Advantageous Effects of Invention

In a case where a communication path between a distribution device and a request device is constituted of communication networks that differ in data transmission amount per unit time and a protocol termination device that interconnects the communication networks exists, a service interruption due to an early session disconnection by the distribution device can be avoided.

### BRIEF DESCRIPTION OF DRAWINGS

FIG. 1 shows a diagram illustrating an overview of a communication system according to one example embodiment of the present invention.

FIG. 2 shows a diagram illustrating an overview of processing on a communication network including a standard protocol termination device.

FIG. 3 shows a functional block diagram of a protocol termination device according to one example embodiment of the present invention.

FIG. 4 shows a hardware configuration diagram of a protocol termination device according to one example embodiment of the present invention.

FIG. 5 shows a diagram illustrating an overview of processing on a communication network including a protocol termination device according to an example embodiment of the present invention.

FIG. 6 shows a first diagram illustrating a process flow on a protocol termination device according to one example embodiment of the present invention.

FIG. 7 shows a second diagram illustrating a process flow on a protocol termination device according to one example embodiment of the present invention.

FIG. 8 shows a third diagram illustrating a process flow on a protocol termination device according to one example embodiment of the present invention.

FIG. 9 shows a diagram illustrating a minimum configuration of a protocol termination device according to one example embodiment of the present invention.

### EXAMPLE EMBODIMENT

A communication system including a protocol termination device according to one example embodiment of the present invention will be described below with reference to the drawings.

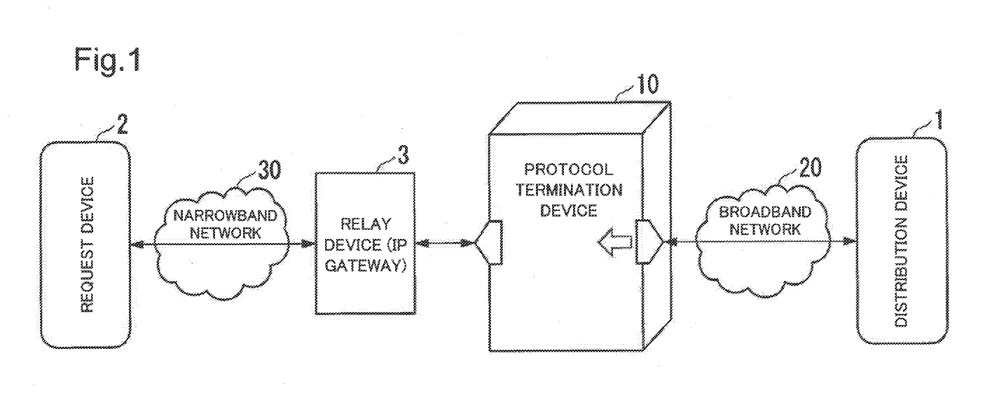

FIG. 1 is a diagram illustrating an overview of a communication system according to the present example embodiment.

As illustrated in the figure, in the communication system, a distribution device 1, a request device 2, a protocol termination device (first relay device) 10, and a relay device (second relay device) 3 are interconnected via communication networks. Specifically, the distribution device 1 and the request device 2 are connected via a first communication network (broadband network) 20 such as the Internet and a second communication network (narrowband network) 30 such as a wireless transmission path. The protocol termination device 10 and the relay device 3 are provided on the transmission path between the distribution device 1 and the request device 2. The protocol termination device 10 receives distribution data from the distribution device 1 and transfers the distribution data to the relay device 3 via the first communication network 20. The relay device 3 transfers the distribution data received from the protocol termination device 10 to the request device 2 via the second communication network 30. Note that the first communication network 20 is a communication network that has a broader bandwidth than the second communication network 30.

In the congestion control system as illustrated in FIG. 1, the request device 2 requests distribution data from the distribution device 1. The distribution device 1 transmits the distribution data to the request device 2 based on the request from the request device 2.

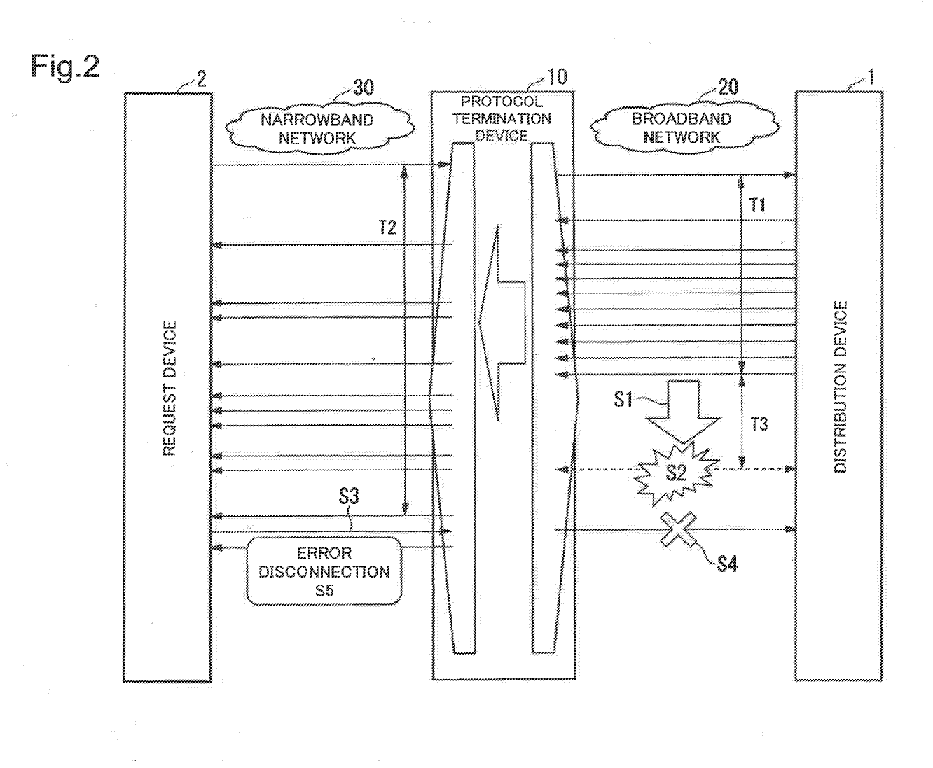

FIG. 2 is a diagram illustrating an overview of processing on a communication network including a conventional protocol terminal device.

The protocol termination device 10 is positioned on a path between a first communication network (broadband network) 20 and a second communication network (narrowband network) 30. Note that, for convenience of explanation, the relay device 3 illustrated in FIG. 1 is omitted from FIG. 2. When the distribution device 1 and the request device 2 communicate with each other, the protocol termination device 10 which relays the communication performs termination processing of a communication protocol for distribution data transmitted from the distribution device 1 connected via the first communication network 20. Further, the protocol termination device 10 transfers, to the request device 2, the distribution data temporarily stored in the protocol termination device 10 by the communication protocol for which the protocol termination device 10 has performed the termination processing. Transferring a communication of a Transmission Control Protocol (TCP) protocol from one communication network to another communication network by performing such protocol termination processing is sometimes referred to as TCP_Splitting.

In the communication system as illustrated in FIG. 2, the distribution device 1 transmits distribution data to the request device 2 based on a distribution request from the request device 2 as described above. In order to efficiently transfer the distribution data transmitted from the distribution device 1 to the request device 2, the protocol termination device 10 transmits a packet (response) in which a large window size value is set in its header or the like to the distribution device 1. In such a case, the distribution device 1 attempts to transmit as much distribution data as possible in a short time period T1, based on the window size. If the size of a reception buffer of the protocol termination device 10 is sufficiently large, the protocol termination device 10 is able to receive and store distribution data in the reception buffer even when the amount of the distribution data transmitted in the short time period T1 is large.

The protocol termination device 10 performs termination processing of communication of distribution data and writes the distribution data into a transmission buffer. The protocol termination device 10 transmits the distribution data from the transmission buffer to the request device 2 connected via the second communication network 30. Here, it is assumed that the second communication network 30 is a narrowband (low bandwidth) wireless network through which a small amount of data per unit time can be transmitted and received compared with that on the first communication network 20. In such a case, the protocol termination device 10 will take nearly a time period T2 that is longer than the time period T1 to transmit, to the request device 2, distribution data received from the distribution device 1 in the time period T1.

On the other hand, the distribution device 1 waits until reception of a next distribution request from the request device 2 after the distribution device 1 has transmitted the total amount of the distribution data in the time period T1. The distribution device 1 starts counting of a timer for determining whether or not to disconnect the session after the transmission of the total amount of the distribution data in the time period T1 (S1). In such a situation, when transfer of distribution data by the protocol termination device 10 has taken the time period T2, the distribution device 1 disconnects the session upon expiration of the timer before the time period T2 has elapsed (S2). The provider or the like that manages the distribution device 1 can reduce a processing load on the distribution device 1 by advancing the expiration time of the timer for a session when a large amount of communication is performed with the request device 2 and the like. In other words, the amount of the session maintained is reduced by advancing the expiration time of the timer. This can reduce the processing load and can release resources such as a central processing unit (CPU). It is assumed that the request device 2 has received the total amount of distribution data near the expiration of the time period T2. When there is a next request, the request device 2 transmits the request to the distribution device 1 using the same session (S3). It is assumed that the distribution device 1, though, has disconnected the session before the request (S2). In this case, the distribution device 1 refuses the connection that uses the same session (S4). In other words, a connection error occurs. The protocol termination device 10 transmits a reply indicating the disconnection caused by the error to the request device 2 (S5). This makes it impossible to provide the service from the distribution device 1 to the request device 2 using the same session.

In contrast, the protocol termination device 10 according to the present example embodiment prevents provision of a service from becoming impossible in this way and is able to efficiently transfer distribution data.

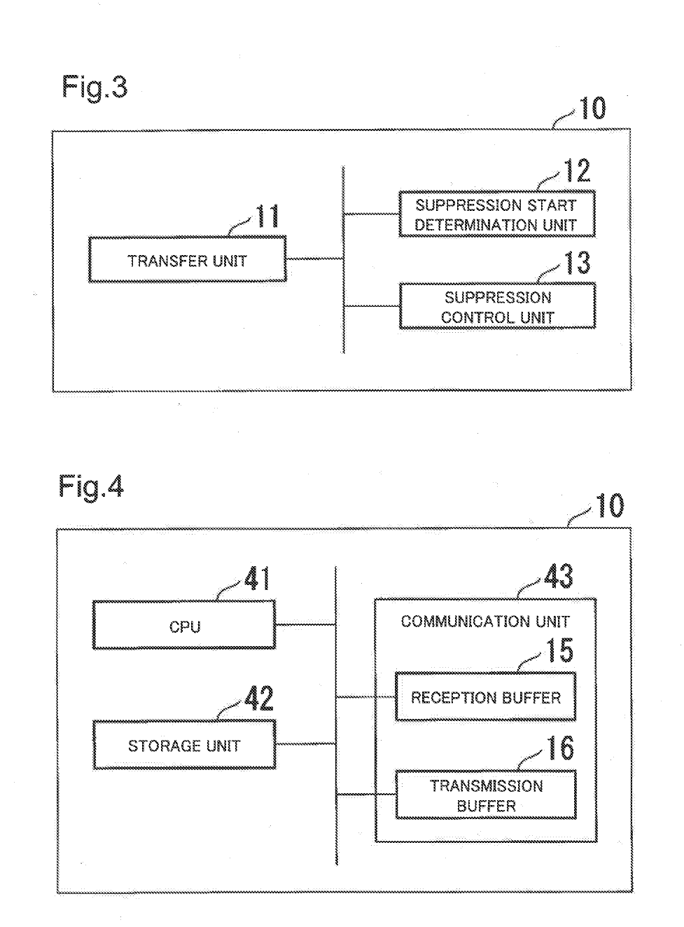

FIG. 3 is a functional block diagram of a protocol termination device.

As illustrated in FIG. 3, the protocol termination device 10 is provided with functions of a transfer unit 11, a suppression start determination unit 12, and a suppression control unit 13 by executing a program after being activated.

The transfer unit 11 transfers distribution data transmitted from a distribution device 1 to a request device 2 which requests for the distribution data.

The suppression start determination unit 12 determines whether or not to start suppression control.

The suppression control unit 13 monitors the transmission amount per unit time of distribution data being transmitted from a transmission buffer 16 (FIG. 4) of the protocol termination device 10 to the request device 2 in transfer processing. Based on a result of the monitoring, the suppression control unit 13 performs suppression control for requesting the distribution device 1 to distribute an amount of data that is equivalent to the transmission amount per unit time.

FIG. 4 is a hardware configuration diagram of the protocol termination device.

As illustrated in the figure, the protocol termination device 10 is a computer that includes pieces of hardware such as a CPU 41, a storage unit 42, and a communication unit 43. The storage unit 42 may be a read only memory (ROM), a random access memory (RAM) or the like. The communication unit 43 includes a reception buffer 15 and a transmission buffer 16.

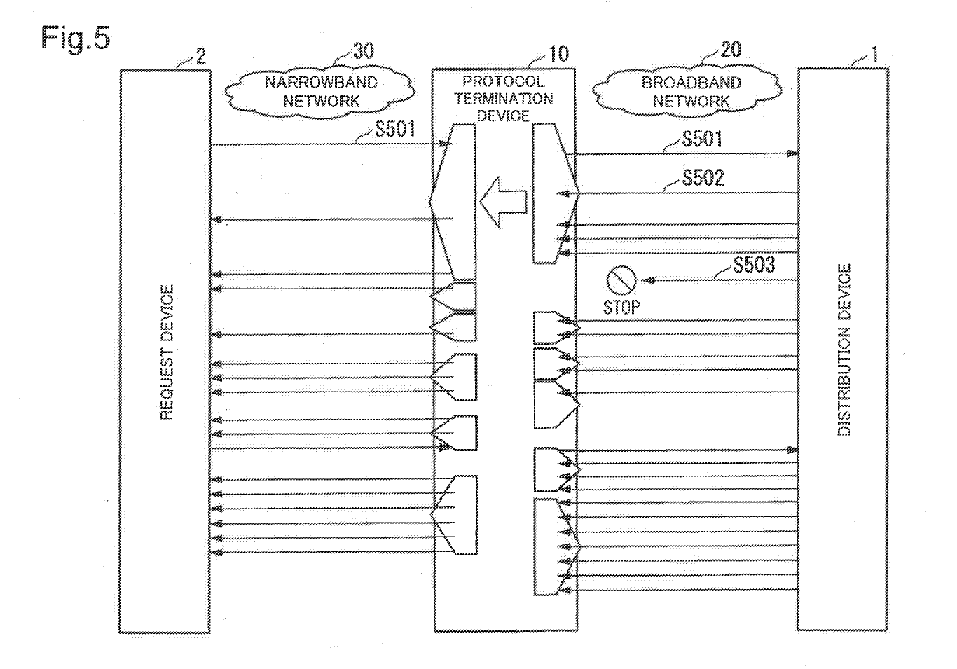

FIG. 5 is a diagram illustrating an overview of processing on a communication network including the protocol termination device according to the present example embodiment.

An overview of processing by the protocol termination device 10 will be described next.

As in the example illustrated in FIG. 2, the protocol termination device 10 is positioned on a path between a first communication network (broadband network) 20 and a second communication network (narrowband network) 30. When a distribution device 1 and a request device 2 perform communication, the protocol termination device 10, which relays the communication, performs termination processing of a communication protocol of distribution data transmitted from the distribution device 1 connected via the first communication network 20. Further, the protocol termination device 10 transfers the distribution data for which the protocol termination device 10 has performed the termination processing to the request device 2.

The request device 2 transmits a distribution request for distribution data to the distribution device 1 (S501). Based on the distribution request from the request device 2, the distribution device 1 transmits the distribution data to the request device 2 (S502). In order to efficiently transfer the distribution data transmitted from the distribution device 1 to the request device 2, the protocol termination device 10 transmits a packet in which a large window size is set in its header or the like to the distribution device 1. The protocol termination device 10 receives packets of the distribution data received from the distribution device 1 and stores the packets in the reception buffer 15 in sequence. The protocol termination device 10 writes the distribution data stored in the reception buffer 15 into the transmission buffer 16 and sequentially transmits the distribution data to the request device 2. At this point in time, the suppression start determination unit 12 of the protocol termination device 10 determines whether or not to start suppression control. For example, when a reception-buffer storage evaluation value obtained by dividing the amount of data stored in the reception buffer 15 of the protocol termination device 10 by the current transmission amount per unit time in the protocol termination device 10 exceeds a threshold (storage amount threshold), the suppression start determination unit 12 determines to start the suppression control. In the suppression control, the suppression control unit 13 of the protocol termination device 10 controls the distribution device 1 to cause the distribution device 1 to transmit a data amount of distribution data that is equivalent to the current transmission amount per unit time on the protocol termination device 10 in such unit time. For example, in the suppression processing, the suppression control unit 13 transmits a transmission hold request to the distribution device 1. The transmission hold request is a window 0 response. The window 0 response is a response in which a window size of “0 (zero)” is specified. When the distribution device 1 receives the window 0 response, the distribution device 1 interrupts the transmission of the distribution data (S503). The distribution device 1 holds the transmission of the distribution data until a response in which a window size of “0” is not specified is returned from the protocol termination device 10. The protocol termination device 10 adjusts the window size to control the distribution device 1 in such a way that the data amount equivalent to the current transmission amount per unit time on the protocol termination device 10 is transmitted in such unit time.

The processing as described above prevents the distribution device 1 from disconnecting a session established with the request device 2 early due to detection of a timeout by the distribution device 1, even when a reduced session timeout (timer expiration time) is set on the distribution device 1.

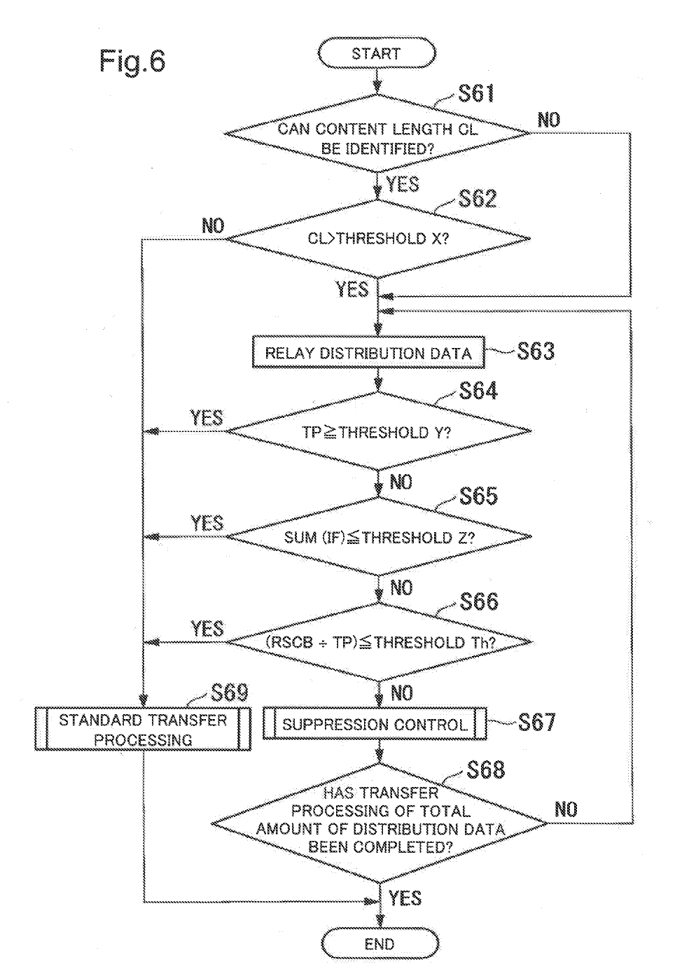

FIG. 6 is a first diagram illustrating a process flow on the protocol termination device.

Next, the process flow on the protocol termination device 10 will be described step by step.

As described using FIG. 5, the distribution device 1 transmits distribution data, based on a distribution request from the request device 2. The transfer unit 11 of the protocol termination device 10 transfers the received distribution data to the relay device 3.

In a situation where the transfer unit 11 is transferring the distribution data to the relay device 3, the suppression start determination unit 12 performs suppression start determination processing. In this processing, the suppression start determination unit 12 determines whether or not a content length (CL) of the distribution data can be identified (step S61). Usually, the distribution device 1 places the content length of distribution data in a header or the like of distribution data and transmits the distribution data. When distribution data distributed by the distribution device 1 is streaming data or encrypted data, the content length of the distribution data may not be able to be checked. When the content length CL of the distribution data can be identified (YES in step S61), the suppression start determination unit 12 performs subsequent suppression start determination processing. On the other hand, when the content length CL cannot be identified (NO in step S61), the suppression start determination unit 12 proceeds to processing in step S63.

When the content length CL of the distribution data can be identified, the suppression start determination unit 12 determines whether or not the content length CL of the distribution data is greater than a content length threshold X (first suppression start threshold (first threshold)) which is set in a reception buffer 15 of the relay device 3 (step S62). When the content length CL of the distribution data is greater than the content length threshold X (YES in step S62), the suppression start determination unit 12 performs the subsequent suppression start determination processing for the distribution data. On the other hand, when the content length CL of the distribution data is equal to or less than the content length threshold X (NO in step S62), the suppression start determination unit 12 determines to perform standard transfer processing in step S69.

When the content length CL cannot be identified in step S61 (NO in step S61) or when the content length CL is greater than the threshold X (YES in step S62), the transfer unit 11 first relays the distribution data (step S63). During the relay, standard transfer processing of controlling in such a way that as much distribution data as possible can be relayed is performed. The suppression start determination unit 12 then calculates a throughput TP indicating the current transmission amount per unit time of the distribution data being transferred from the transmission buffer 16. The suppression start determination unit 12 determines whether or not the current throughput TP is equal to or greater than a throughput threshold Y (second suppression start threshold (second threshold)) (step S64). The throughput threshold Y is a value for determining whether the current throughput TP is sufficient. When the throughput TP is less than the throughput threshold Y (NO in step S64), it indicates that the throughput TP is insufficient. When the throughput TP is sufficient, i.e., when the throughput TP is equal to or greater than the threshold Y (YES in step S64), the suppression start determination unit 12 determines to perform the standard transfer processing (step S69). On the other hand, when the throughput TP is insufficient, i.e., when the throughput TP is less than the threshold Y (NO in step S64), the suppression start determination unit 12 performs the subsequent suppression start determination processing.

In the subsequent suppression start determination processing, the suppression start determination unit 12 calculates the sum SUM (IF) of data amounts of the distribution data for which an acknowledgement has not been received from the request device 2 among the distribution data transmitted to the request device 2. “IF” is an abbreviation for “inflight” and indicates the data amount of packets accumulated between the protocol termination device 10 and the request device 2. Whether or not an acknowledge has been received is identified based on whether or not an acknowledgement (ACK) in Hypertext Transfer Protocol (HTTP) communication has been returned from the request device 2 to the distribution device 1. When data (packet) indicating ACK for distribution data has been received from the request device 2 after the protocol termination device 10 transferred the distribution data to the relay device 3, the protocol termination device 10 detects that the distribution data have arrived at the request device 2. On the other hand, data (packets) for which an ACK has not been returned from the request device 2 to the protocol termination device 10 may still be left in the buffer of the relay device 3. The suppression start determination unit 12 stores information about packets transmitted to the request device 2 and is able to calculate SUM (IF) by summating the data amounts of packets for which an ACK has not been returned.

The suppression start determination unit 12 of the protocol termination device 10 calculates the amount of data that have been transferred from the protocol termination device 10 to the relay device 3 but have not yet arrived at the request device 2 by calculating SUM (IF). The suppression start determination unit 12 of the protocol termination device 10 compares SUM (IF) with a data amount indicating a reception buffer threshold Z (third suppression start threshold (third threshold)) of the relay device 3 to determine whether SUM (IF) is equal to or less than the data amount indicating the reception buffer threshold Z of the relay device 3 (step S65). When SUM (IF) is greater than the data amount indicating the reception buffer threshold Z of the relay device 3 (NO in step S65), the suppression start determination unit 12 performs the subsequent suppression start determination processing. On the other hand, when SUM (IF) is equal to or less than the data amount indicating the reception buffer threshold Z of the relay device 3 (YES in step S65), the suppression start determination unit 12 determines to perform standard relay processing (step S69). When SUM (IF) is equal to or less than the data amount indicating the reception buffer threshold Z of the relay device 3, it is likely that the distribution data are smoothly flowing and therefore the possibility that the session will be disconnected by the distribution device 1 is low. Therefore, the standard relay processing is performed. On the other hand, when SUM (IF) is greater than the data amount indicating the reception buffer threshold Z of the relay device 3, the suppression start determination unit 12 determines to perform the subsequent suppression start determination processing.

In the subsequent suppression start determination processing, the suppression start determination unit 12 calculates a reception-buffer storage evaluation value by dividing a Receive Socket Buffer Size (RSCB) which is the amount of data to be stored in the reception buffer 15 of the protocol termination device 10 by a throughput TP which is the transmission amount per unit time (RSCB÷TP). The suppression start determination unit 12 compares the reception-buffer storage evaluation value with a storage amount threshold Th to determine whether or not the reception-buffer storage evaluation value is equal to or less than the storage amount threshold Th (step S66). When the reception-buffer storage evaluation value is equal to or less than the storage amount threshold Th (YES in step S66), the efficiency of transfer by the protocol termination device 10 to the relay device 3 is high. The suppression start determination unit 12 therefore determines to perform standard relay processing (step S69). On the other hand, when the reception-buffer storage evaluation value is greater than the storage amount threshold Th (NO in step S66), the efficiency of transfer of data by the protocol termination device 10 to the relay device 3 is low and the possibility that the session will be disconnected by the distribution device 1 is high. Therefore, when the reception-buffer storage evaluation value is greater than the storage amount threshold Th, the suppression start determination unit 12 determines to start the suppression control (step S67).

When the suppression start determination unit 12 determines to start the suppression control, the suppression control unit 13 monitors the transmission amount per unit time of the distribution data being transmitted from the transmission buffer 16 of the protocol termination device 10 to the request device 2. The suppression control unit 13 requests the distribution device 1 to distribute a transmission amount per unit of time of the distribution data that is equivalent to that amount of transmission per unit time. In response to such request, the distribution device 1 transmits, in the unit time, an amount of the distribution data that is equivalent to the data amount per unit time transferred by the protocol termination device 10 to the request device 2 (step S67). After the end of processing of the suppression control, the suppression control unit 13 determines whether or not the transfer processing of the total amount of the distribution data has been performed (step S68) and, when the transfer processing of the total amount of the distribution data has been performed (YES in step S68), the suppression control unit 13 ends the processing for the distribution data. On the other hand, when the total amount of the distribution data have not yet been transferred (NO in step S68), the suppression control unit 13 repeats the process from the processing in step S63 for the distribution data.

Note that the amount of distribution data that are candidates for the suppression control is reduced in the processing in steps S62, S64, S65 and S66. The reduction can narrow down the distribution data to ultimate distribution data for which the suppression control is performed. As a result, the load of processing other than standard transfer processing on the protocol termination device 10 can be reduced. Note that processing of any one or more of steps S62, S64, and S65 may be omitted. Note that, according to the flowchart of FIG. 6, when the content length CL of the distribution data is greater than the content length threshold X in step S62 (YES in step S62), the suppression start determination unit 12 performs the subsequent suppression start determination processing. However, the control start determination unit 12 may perform the subsequent suppression start determination processing when the content length CL of the distribution data is equal to or greater than the content length threshold X.

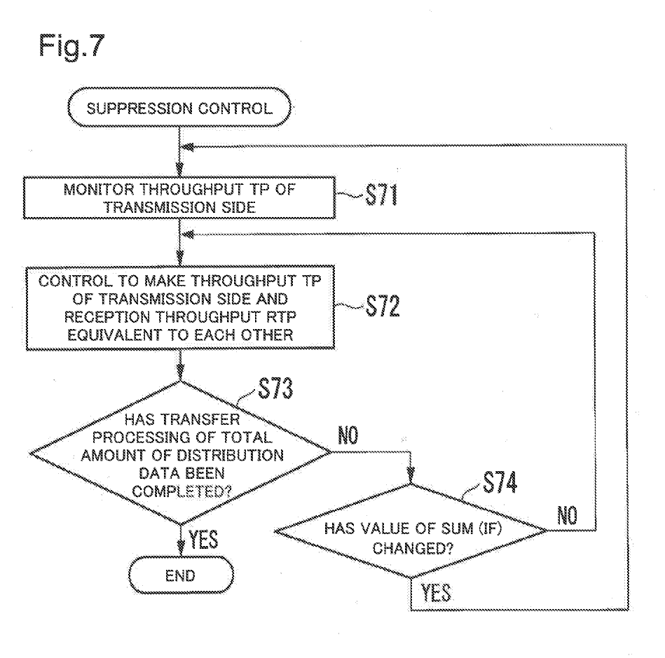

FIG. 7 is a second diagram illustrating a process flow on the protocol termination device.

In FIG. 7, a specific example of the suppression control processing (step S67) described above using the flowchart of FIG. 6 will be described.

When the suppression control unit 13 starts suppression control, the suppression control unit 13 monitors the throughput TP of the transmission side in the protocol termination device 10 (step S71). The suppression control unit 13 controls in such a way that the throughput TP of the transmission side in the protocol termination device 10 and a reception throughput RTP of the reception side in the protocol terminal device 10 are equivalent to each other (step S72). Specifically, the suppression control unit 13 transmits a window 0 response to the distribution device 1 depending on the throughput TP of the transmission side. This causes the distribution device 1 to interrupt and hold transfer of distribution data after receiving the window 0. Since transmission of excess distribution data by the distribution device 1 is held, the throughput TP of the transmission side in the protocol termination device 10 and the reception throughput RTP of the reception side in the protocol termination device 10 are kept equivalent to each other. In the distribution-data-transfer-hold state, the distribution device 1 transmits a signal that asks a window size to the protocol termination device 10. When, as a result, the distribution device 1 receives a response that is not a window 0 response and indicates a value greater than window size 0, the distribution device 1 restarts the transmission of the distribution data. In this way, the suppression control unit 13 controls in such a way that the throughput TP of the transmission side in the protocol termination device 10 and the reception throughput RTP of the reception side in the protocol termination device 10 become equivalent to each other.

The suppression control unit 13 determines whether the transfer processing of the total amount of the distribution data has been completed (step S73) and, when the transfer processing of the total amount of the distribution data has been completed (YES in step S73), the suppression control unit 13 ends the suppression control processing for the distribution data. On the other hand, when the transmission processing of the total amount of the distribution data has not been completed (NO in step S73), the suppression control unit 13 determines whether or not the value of SUM (IF) per unit time has changed (step S74). When the value of SUM (IF) has changed (YES in step S74), the suppression control unit 13 repeats the process from the processing in step S71 and calculates new throughput TP of the transmission side. On the other hand, when the value of SUM (IF) has not changed (NO in step S74), the suppression control unit 13 repeats the process from the processing in step S72.

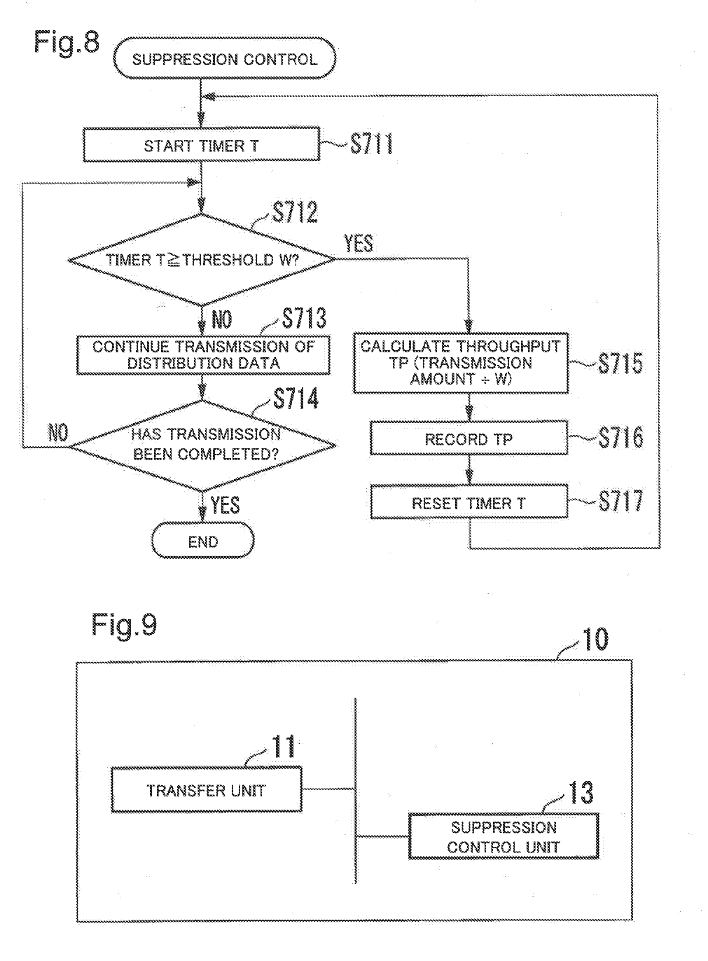

FIG. 8 is a third diagram illustrating a process flow on the protocol termination device.

In FIG. 8, the monitoring processing of throughput TP described above (step S71) using the flowchart of FIG. 7 will be described in detail.

When the suppression control unit 13 starts monitoring the throughput TP, the suppression control unit 13 starts a timer T (step S711). The suppression control unit 13 determines whether or not the timer T is equal to or greater than a threshold W for determining whether the timer T has expired (step S712). When the timer T is less than the threshold W (NO in step S712), the suppression control unit 13 continues transmission of the distribution data from the transmission buffer 16 (step S713). The suppression control unit 13 then determines whether or not the transmission of the total amount of the distribution data has been completed (step S714). When the transmission has been completed (YES in step S714), the suppression control unit 13 ends the monitoring processing for the distribution data. On the other hand, when the transmission of the total amount of the distribution data has not been completed (NO in step S714), the suppression control unit 13 repeats the process from the processing in step S712. When the suppression control unit 13 determines in step S712 that the timer T is equal to or greater than the threshold W (YES in step S712), the suppression control unit 13 calculates a throughput TP by dividing the data amount of the distribution data that have been transmitted in the period between the start of the timer T and the expiration thereof by the time indicated by the threshold W (step S715). In this way, the throughput TP can be calculated. Further, the suppression control unit 13 records the throughput TP in a memory or the like (step S716). The suppression control unit 13 resets the timer T (step S717). The suppression control unit 13 repeats, while performing the suppression control, the process from processing in step S711 to processing in step S717 described above in monitoring of the throughput TP.

According to the processing described above, the protocol termination device 10 controls the data amount per unit time that is being distributed from the distribution device 1 in such a way that the throughput TP of the transmission side of the protocol termination device 10 and the reception throughput RTP of the reception side of the protocol termination device 10 become equivalent to each other. This eliminates the timing at which the distribution device 1 disconnects the session due to timeout. Accordingly, an operation of early disconnection of the session due to no response from the request device 2 at the distribution device 1 based on its own rules can be avoided.

FIG. 9 is a diagram illustrating a minimum configuration of a protocol termination device according to one example embodiment.

As illustrated in the figure, the protocol termination device 10 includes at least a transfer unit 11 and a suppression control unit 13.

The protocol termination device 10 described above efficiently transfers distribution data by storing as much distribution data as possible in a reception buffer 15. Specifically, when the protocol termination device 10 notifies the distribution device 1 of the capacity of the reception buffer 15, the protocol termination device 1 constantly keeps an advertised window size large without reducing its value. Thus, a transmission amount can be increased immediately by using data stored in the reception buffer 15 when congestion or efficiency on the transmission side in the protocol termination device 10 is relieved or improved. In addition, transfer processing can be more efficiently performed by acquiring distribution data from the distribution device 1 as well with an improved transmission data amount per unit time while data stored in the reception buffer 15 is being transmitted to the request device 2 side.

Further, the protocol termination device 10 described above does not require to perform suppression of reception performance of a communication interface that interfaces to the distribution device and resources of itself (the protocol termination device 10) in order to achieve the effect. As a commonly used method for suppressing reception performance, there is a method in which a reception buffer size is reduced and the upper limit of communication performance itself in communication with a distribution device 1 is reduced, thereby decreasing an instantaneous data reception speed. In this method, however, its effect varies depending on a state of communication (round trip time: RTT) with the distribution device 1 and a reliable effect cannot be achieved. Further, if communication performance is excessively limited with the aim of achieving a greater effect, the protocol termination device 10 itself may become a bottleneck in the communication performance when the state of communication with a request device 2 is recovered. In contrast, the example embodiment descried above is a method which is able to ensure original communication performance when suppression control is stopped, by limiting reception without limiting the communication performance itself.

Further, the protocol termination device 10 described above performs suppression control when the content length CL of distribution data transmitted from the distribution device is equal to or greater than a threshold or the content length CL is greater than the threshold. Accordingly, when the content length CL is small, the protocol termination device 10 performs standard transfer processing. Thus, the protocol termination device 10 never performs suppression control for distribution data that has a small content length CL and therefore does not decrease the communication efficiency of the distribution data. Further, even if the content length cannot be identified, the protocol termination device 10 periodically monitors the transmission efficiency (throughput TP) of the distribution data and, only when the efficiency has decreased, performs suppression control. Therefore, the protocol termination device 10 does not affect the communication efficiency of the distribution data from the beginning of transmission processing.

Each of the devices described above includes a computer system therein. A program for causing each device to perform the processing described above is stored on a computer-readable recording medium of the device and the processing described above is accomplished by the computer of the device reading and executing the program. The computer-readable recording medium herein refers to a magnetic disk, a magneto-optical disc, a CD-ROM, a DVD-ROM, a semiconductor memory and the like.

The computer program may be delivered to a computer via a communication line, and the computer that has received the delivery may execute the program.

Further, the program described above may be a program for implementing some of the functions of the processing units described above. Moreover, the program may be a so-called difference file (difference program), which can be used in conjunction with a program already recorded in a computer system to implement the functions described above.

This application is based upon and claims the benefit of priority from Japanese Patent Application No. 2016-185261, filed on Sep. 23, 2016, the disclosure of which is incorporated herein in its entirety by reference.

### INDUSTRIAL APPLICABILITY

According to the present invention, in a case where a communication path between a distribution device and a request device is constituted of communication networks that differ in data transmission amount per unit time and a protocol termination device that interconnects the communication networks exists, a service interruption due to an early session disconnection by the distribution device can be avoided.

### REFERENCE SIGNS LIST

1 Distribution device
2 Request device
3 Relay device
10 Protocol termination device
11 Transfer unit
12 Suppression start determination unit
13 Suppression control unit
15 Reception buffer
16 Transmission buffer
20 First communication network
30 Second communication network

1. A protocol termination device comprising:
a transfer unit configured to transfer distribution data transmitted from a distribution device to a request device that has requested the distribution data; and
a suppression control unit configured to perform suppression control for monitoring a transmission amount per unit time of the distribution data being transmitted from a transmission buffer of the protocol termination device to the request device in the transfer processing and requesting transmission of the distribution data having a data amount that is equivalent to the transmission amount per unit time, from the distribution device.

2. The protocol termination device according to claim 1, wherein
the suppression control unit determines a change in a data amount of the distribution data for which an acknowledgement is not received from the request device among the distribution data that have been transferred to the request device, and, when the data amount is changed, recalculates the transmission amount per unit time.

3. The protocol termination device according to claim 1, further comprising:
a suppression start determination unit configured to determine to perform the suppression control, when a reception-buffer storage evaluation value acquired by dividing an amount of data stored in a reception buffer of the protocol termination device by the transmission amount per unit time exceeds a storage amount threshold.

4. The protocol termination device according to claim 1, wherein
the suppression control unit transmits a transmission hold request to the distribution device in the suppression control.

5. The protocol termination device according to claim 4, wherein
the transmission hold request is a response in which 0 is specified as a window size.

6. The protocol termination device according to claim 3, wherein
the suppression start determination unit determines whether a content length of the distribution data from a start of transmission to an end of transmission is equal to or greater than a first threshold, and, when the content length is equal to or greater than the first threshold, determines to perform the suppression control.

7. The protocol termination device according to claim 3, wherein
the suppression start determination unit determines whether a transmission amount per unit time of the distribution data being transmitted to the request device is less than a second threshold, and, when the transmission amount per unit time is less than the second threshold, determines to perform the suppression control.

8. The protocol termination device according to claim 3, wherein,
when a data amount of the distribution data for which an acknowledgement is not received from the request device among the distribution data that have been transferred to the request device is greater than a third threshold, the suppression start determination unit determines to perform the suppression control.

9. A relay method comprising:
transferring distribution data transmitted from a distribution device to a request device that has requested the distribution data; and
performing suppression control for monitoring a transmission amount per unit time of the distribution data being transmitted from a transmission buffer of an own device to the request device in the transfer processing, and requesting transmission of the distribution data having a data amount that is equivalent to the transmission amount per unit time, from the distribution device.

10. A non-transitory computer readable recording medium recorded with a program for causing a computer to execute the processing of:
transferring distribution data transmitted from a distribution device to a request device that has requested the distribution data; and
performing suppression control for monitoring a transmission amount per unit time of the distribution data being transmitted from a transmission buffer of an own device to the request device in the transfer processing, and requesting transmission of the distribution data having a data amount that is equivalent to the transmission amount per unit time, from the distribution device.
